(19) United States
(12) Patent Application Publication
(10) Pub. No.: US 2013/0177237 A1
(43) Pub. Date: Jul. 11, 2013

(54) STEREO-VISION OBJECT DETECTION SYSTEM AND METHOD

(71) Applicant: Gregory Gerhard SCHAMP, South Lyon, MI (US)

(72) Inventor: Gregory Gerhard SCHAMP, South Lyon, MI (US)

(21) Appl. No.: 13/737,551

(22) Filed: Jan. 9, 2013

Related U.S. Application Data
(60) Provisional application No. 61/584,354, filed on Jan. 9, 2012.

(51) Int. Cl. G06K 9/00

(52) U.S. Cl. CPC G06K 9/00624
USPC 382/154

(57) ABSTRACT

An object in a visual scene is detected responsive to one or more void regions in an associated range-map image generated from associated stereo image components. In one aspect, each element of a valid-count vector contains a count of a total number of valid range values at a corresponding column position from a plurality of rows of the range-map image. The valid-count vector, or a folded version thereof, is filtered, and an integer approximation thereof is differentiated so as to provide for identifying one or more associated void regions along the plurality of rows of the range-map image. For each void region, the image pixels of an associated prospective near-range object are identified as corresponding to one or more modes of a histogram providing a count of image pixels with respect to image pixel intensity, for image pixels from one of the stereo image components within the void region.

### CROSS-REFERENCE TO RELATED APPLICATIONS

The instant application claims benefit of U.S. Provisional Application Ser. No. 61/584,354 filed on Jan. 9, 2012, which is incorporated herein by reference in its entirety.

### BRIEF DESCRIPTION OF THE DRAWINGS

FIG. 1 illustrates an left-side view of a vehicle encountering a plurality of vulnerable road users (VRU), and a block diagram of an associated stereo-vision object detection system;

FIG. 2 illustrates a top view of a vehicle and a block diagram of a stereo-vision object detection system thereof;

FIG. 3a illustrates a right-side view of a stereo-vision object detection system incorporated in a vehicle, viewing a relatively near-range object;

FIG. 3b illustrates a front view of the stereo cameras of the stereo-vision object detection system incorporated in a vehicle, corresponding to FIG. 3a;

FIG. 3c illustrates a top view of the stereo-vision object detection system incorporated in a vehicle, corresponding to FIGS. 3a and 3b;

FIG. 4a illustrates a geometry of a stereo-vision system;

FIG. 4b illustrates an imaging-forming geometry of a pinhole camera;

FIG. 5 illustrates a front view of a vehicle and various stereo-vision camera embodiments of a stereo-vision system of an associated stereo-vision object detection system;

FIG. 6 illustrates a single-camera stereo-vision system;

FIG. 7 illustrates a block diagram of an area-correlation-based stereo-vision processing algorithm;

FIG. 8 illustrates a plurality of range-map images of a pedestrian at a corresponding plurality of different ranges from a stereo-vision system, together with a single-camera intensity-image of the pedestrian at one of the ranges;

FIG. 9 illustrates a block diagram of the stereo-vision object detection system illustrated in FIGS. 1, 2 and 3a through 3c;

FIG. 10 illustrates a flow chart of a first portion of stereo-vision object detection process carried out by the stereo-vision object detection system illustrated in FIG. 9;

FIG. 11 illustrates a range-map image associated with the stereo-vision object detection process illustrated in FIG. 10;

FIG. 12 illustrates range values corresponding to views along three different elevation angles illustrated in FIG. 3a corresponding to three different rows of the range-map image illustrated in FIG. 11;

FIG. 13 illustrates a vector of a count of valid range values from the three different rows of the range-map image, illustrated in FIGS. 11 and 12, for the corresponding three different elevation angles illustrated in FIG. 3a;

FIG. 14 illustrates a folded valid-count vector generated by sequentially combining every two columns of the valid-count vector illustrated in FIG. 13;

FIGS. 15a and 15b respectively illustrate an integer-filtered-folded valid-count vector and a corresponding vector of differential values for a situation of a near-range object within an intermediate portion of the field-of-view of the stereo-vision system;

FIGS. 15c and 15d respectively illustrate an integer-filtered-folded valid-count vector and a corresponding vector of differential values for a situation of near-range objects within left-most and intermediate portions of the field-of-view of the stereo-vision system;

FIGS. 15e and 15f respectively illustrate an integer-filtered-folded valid-count vector and a corresponding vector of differential values for a situation of a near-range object within a right-most portion of the field-of-view of the stereo-vision system;

FIG. 16 illustrates a flow chart of a second portion of stereo-vision object detection process carried out by the stereo-vision object detection system illustrated in FIG. 9;

FIG. 17 illustrates an intensity-image from one of the two stereo-vision cameras corresponding to the range-map image illustrated in FIG. 11;

FIG. 18 illustrates an image-intensity histogram of a portion of the intensity-image illustrated in FIG. 17 within an associated void region; and

FIG. 19 illustrates portions of the intensity-image of FIG. 17 corresponding to principal modes of the image-intensity histogram illustrated in FIG. 18.

### DESCRIPTION OF EMBODIMENT(S)

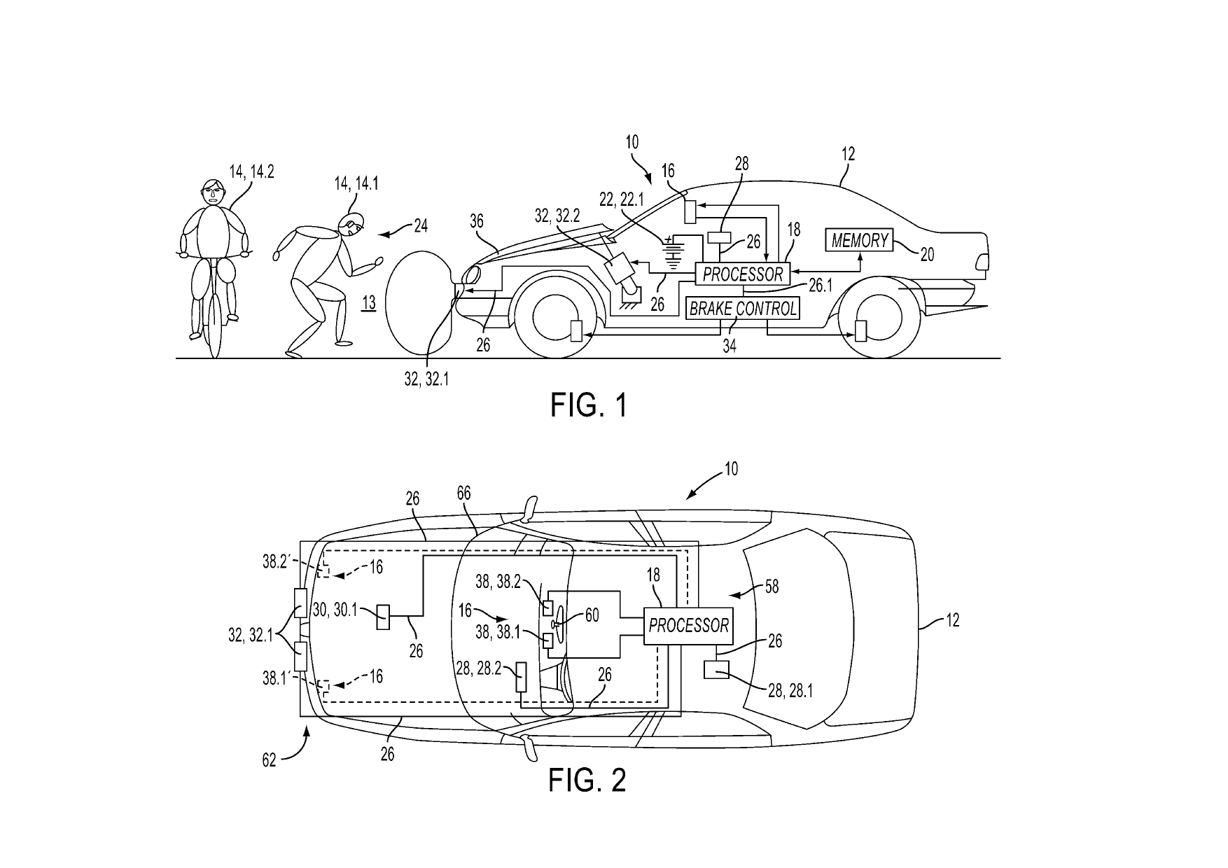

Referring to FIGS. 1, 2 and 3a-3c, a stereo-vision object detection system 10 is incorporated in a vehicle 12 so as to provide for viewing the region 13 in front of the vehicle 12 so as to provide for detecting objects therein, for example, in accordance with the teachings of U.S. patent application Ser. No. 11/658,758 filed on 29 Sep. 2008, entitled Vulnerable Road User Protection System, and U.S. patent application Ser. No. 13/286,656 filed on 16 Nov. 2011, entitled Method of Identifying an Object in a Visual Scene, both of which are incorporated herein by reference, so as to provide for detecting and protecting a vulnerable road user 14 (hereinafter “VRU 14”) from a collision with the vehicle 12. Examples of VRUs 14 include a pedestrian 14.1 and a pedal cyclist 14.2.

The stereo-vision object detection system 10 incorporates a stereo-vision system 16 operatively coupled to a processor 18 incorporating or operatively coupled to a memory 20, and powered by a source of power 22, e.g. a vehicle battery 22.1. Responsive to information from the visual scene 24 within the field of view of the stereo-vision system 16, the processor 18 generates one or more signals 26 to one or more associated driver warning devices 28, VRU warning devices 30, or VRU protective devices 32 so as to provide, by one or more of the following ways, for protecting one or more VRUs 14 from a possible collision with the vehicle 12: 1) by alerting the driver 33 with an audible or visual warning signal from a audible warning device 28.1 or a visual display or lamp 28.2 with sufficient lead time so that the driver 33 can take evasive action to avoid the collision; 2) by alerting the VRU 14 with an audible or visual warning signal—e.g. by sounding a vehicle horn 30.1 or flashing the headlights 30.2—so that the VRU 14 can stop or take evasive action; 3) by generating a signal 26.1 to a brake control system 34 so as to provide for automatically braking the vehicle 12 if a collision with a VRU 14 becomes likely, or 4) by deploying one or more VRU protective devices 32—for example, an external air bag 32.1 or a hood actuator 32.2 in advance of a collision if a collision becomes inevitable. For example, in one embodiment, the hood actuator 32.2—for example, either a pyrotechnic, hydraulic or electric actuator—cooperates with a relatively compliant hood 36 so as to provide for increasing the distance over which energy from an impacting VRU 14 may be absorbed by the hood 36.

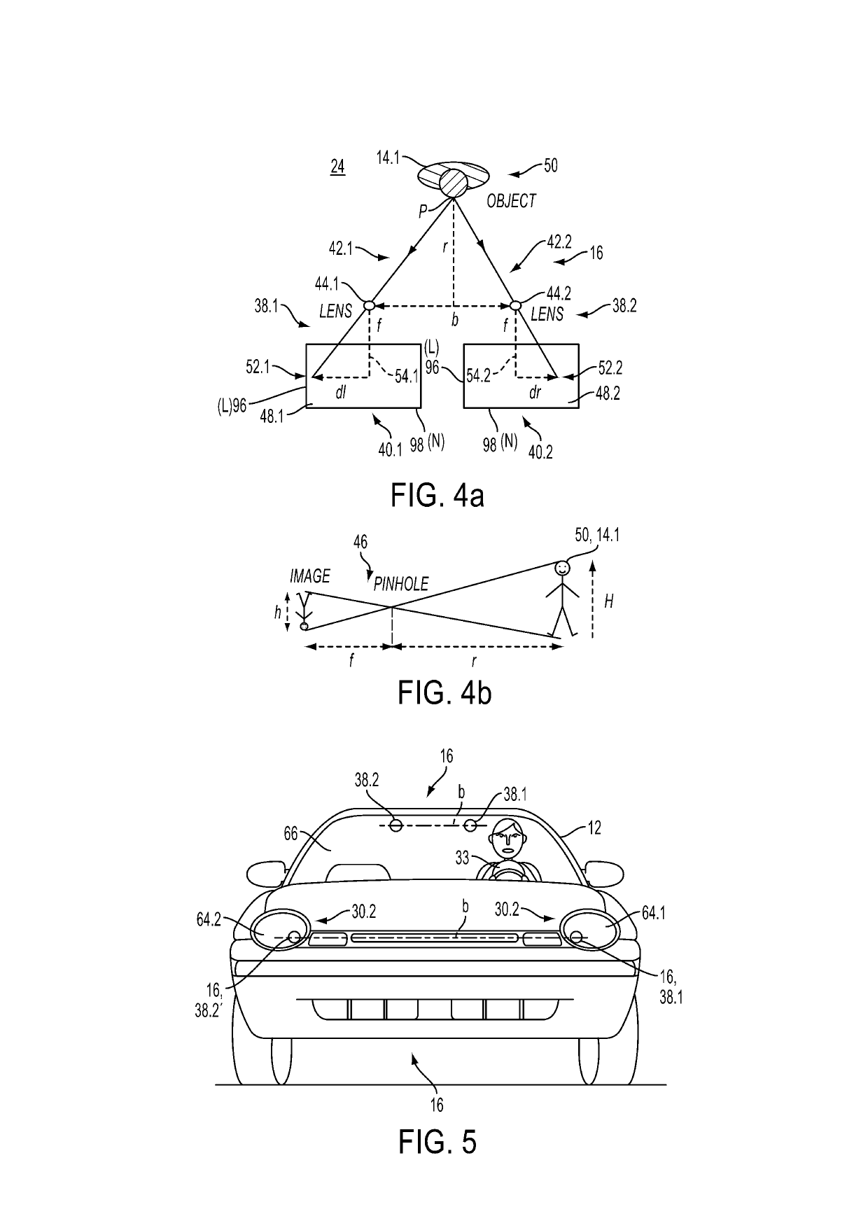

Referring also to FIG. 4a, in one embodiment, the stereo-vision system 16 incorporates at least one stereo-vision camera 38 that provides for acquiring first 40.1 and second 40.2 stereo intensity-image components, each of which is displaced from one another by a baseline b distance that separates the associated first 42.1 and second 42.2 viewpoints. For example, as illustrated in FIGS. 2, 3b, 3c, 4a and 5, first 38.1 and second 38.2 stereo-vision cameras having associated first 44.1 and second 44.2 lenses, each having a focal length f, are displaced from one another such that the optic axes of the first 44.1 and second 44.2 lenses are separated by the baseline b distance. Each stereo-vision camera 38 can be modeled as a pinhole camera 46, and the first 40.1 and second 40.2 stereo intensity-image components are electronically recorded at the corresponding coplanar focal planes 48.1, 48.2 of the first 44.1 and second 44.2 lenses. For example, the first 38.1 and second 38.2 stereo-vision cameras may comprise wide dynamic range electronic cameras that incorporate focal plane CCD (charge coupled device) or CMOS (complementary metal oxide semiconductor) arrays and associated electronic memory and signal processing circuitry. For a given object 50 located a range r distance from the first 44.1 and second 44.2 lenses, the associated first 40.1 and second 40.2 stereo intensity-image components are taken from associated different first 42.1 and second 42.2 viewpoints. For a given point P on the object 50, the first 52.1 and second 52.2 intensity images of that point P are offset from the first 54.1 and second 54.2 image centerlines of the associated first 40.1 and second 40.2 stereo intensity-image components by a first offset dl for the first stereo intensity-image component 40.1 (e.g. left image), and a second offset dr for the second stereo intensity-image component 40.2 (e.g. right image), wherein the first dl and second dr offsets are in a plane containing the baseline b and the point P, and are in opposite directions relative to the first 54.1 and second 54.2 image centerlines. The difference between the first dl and second dr offsets is called the disparity d, and is directly related to the range r of the object 50 in accordance with the following equation:

r=b·f/d, where d=dl−dr (1)

Referring to FIG. 4b, the height H of the object 50 can be derived from the height H of the object image 56 based on the assumption of a pinhole camera 46 and the associated image forming geometry.

Referring to FIGS. 2 and 5, in one embodiment, the first 38.1 and second 38.2 stereo-vision cameras are located along a substantially horizontal baseline b within the passenger compartment 58 of the vehicle 12, e.g. in front of a rear view mirror 60, so as to view the visual scene 24 through the windshield 66 of the vehicle 12. In another embodiment, the first 38.1′ and second 38.2′ stereo-vision cameras are located at the front 62 of the vehicle 12 along a substantially horizontal baseline b, for example, within or proximate to the left 64.1 and right 64.2 headlight lenses, respectively.

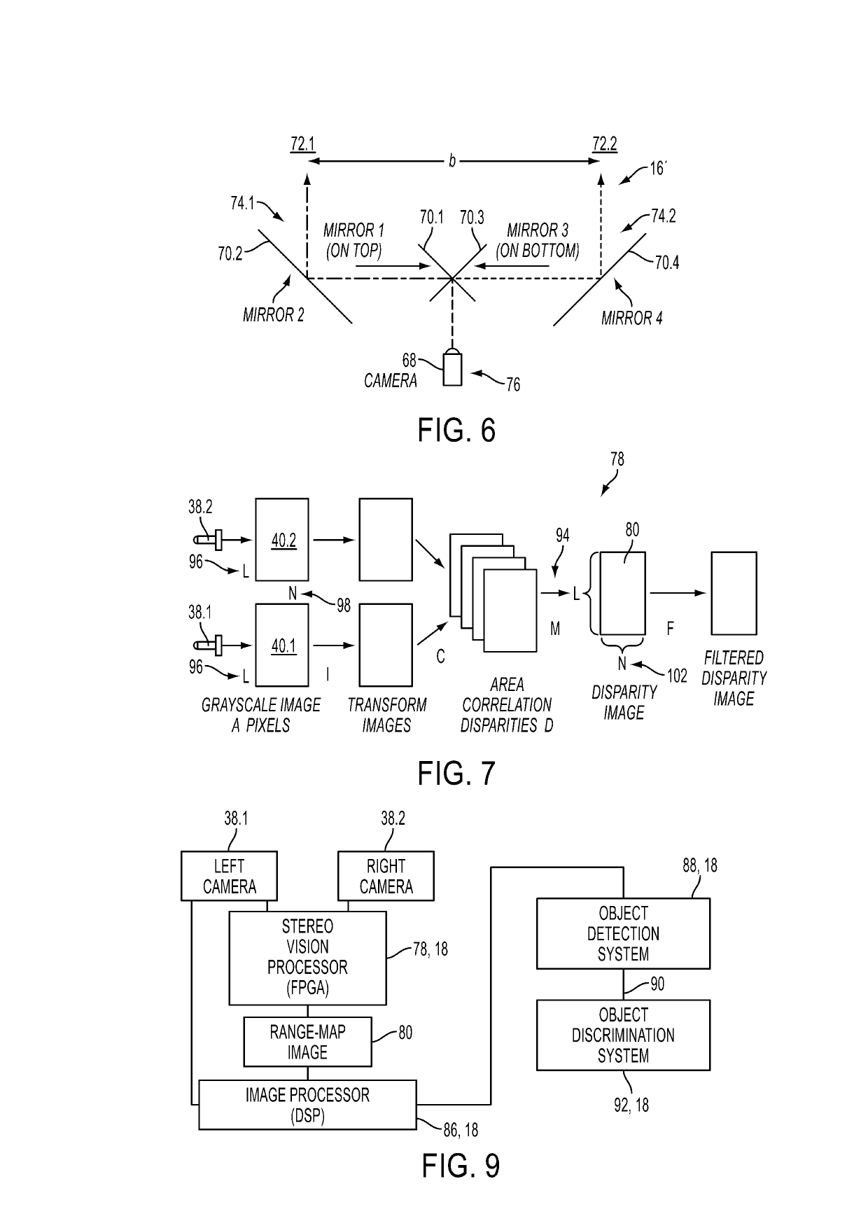

Referring to FIG. 6, in yet another embodiment, a stereo-vision system 16′ incorporates a single camera 68 that cooperates with a plurality of flat mirrors 70.1, 70.2, 70.3, 70.4, e.g. first surface mirrors, that are adapted to provide for first 72.1 and second 72.2 viewpoints that are vertically split with respect to one another, wherein an associated upper portion of the field of view of the single camera 68 looks out of a first stereo aperture 74.1 and an associated lower part of the field of view of the single camera 68 looks out of a second stereo aperture 74.2, wherein the first 74.1 and second 74.2 stereo apertures are separated by a baseline b distance. If the detector 76 of the single camera 68 is square, then each corresponding field of view would have a horizontal-to-vertical aspect ratio of approximately two to one, so as to provide for a field of view that is much greater in the horizontal direction than in the vertical direction. In the embodiment illustrated in FIG. 6, the field of view of the single camera 68 is divided into the upper and lower fields of view by a first mirror 70.1 and a third mirror 70.3, respectively, that are substantially perpendicular to one another and at an angle of 45 degrees to the baseline b. The first mirror 70.1 is located above the third mirror 70.3 and cooperates with a relatively larger left-most second mirror 70.2 so that the upper field of view of the single camera 68 provides a first stereo intensity-image component 40.1 from the first viewpoint 72.1 (i.e. left viewpoint). The third mirror 70.3 cooperates with a relatively larger right-most fourth mirror 70.4 so that the lower field of view of the single camera 68 provides a second stereo intensity-image component 40.2 from the second viewpoint 72.2 (i.e. right viewpoint).

Referring to FIG. 7, a stereo-vision processor 78 provides for generating a range-map image 80 (also known as a range image or disparity image) of the visual scene 24 from the individual grayscale images from the stereo-vision camera(s) 38 for each of the first 42.1 and second 42.2 viewpoints. The range-map image 80 provides for each pixel 104, the range r from the stereo-vision system 16 to the object. Alternatively or additionally, the range-map image 80 may provide a vector of associated components, e.g. down-range (Z), cross-range (X) and height (Y) of the object relative to an associated reference coordinate system fixed to the vehicle 12. In another embodiment, in addition to the range r from the stereo-vision system 16 to the object, the stereo-vision processor 78 could also be adapted to provide the azimuth and elevation angles of the object relative to the stereo-vision system 16. For example, the stereo-vision processor 78 may operate in accordance with a system and method disclosed in U.S. Pat. No. 6,456,737, which is incorporated herein by reference. Stereo imaging overcomes many limitations associated with monocular vision systems by recovering an object's real-world position through the disparity d between left and right intensity-image pairs, i.e. first 40.1 and second 40.2 stereo intensity-image components, and relatively simple trigonometric calculations.

In accordance with one embodiment, an associated area correlation algorithm of the stereo-vision processor 78 provides for matching corresponding areas of the first 40.1 and second 40.2 stereo intensity-image components so as to provide for determining the disparity d therebetween and the corresponding range r thereof. The extent of the associated search for a matching area can be reduced by rectifying the input intensity images (I) so that the associated epipolar lines lie along associated scan lines of the associated first 38.1 and second 38.2 stereo-vision cameras. This can be done by calibrating the first 38.1 and second 38.2 stereo-vision cameras and warping the associated input intensity images (I) to remove lens distortions and alignment offsets between the first 38.1 and second 38.2 stereo-vision cameras. Given the rectified images (C), the search for a match can be limited to a particular maximum number of offsets (D) along the baseline direction, wherein the maximum number is given by the minimum and maximum ranges r of interest. For implementations with multiple processors or distributed computation, algorithm operations can be performed in a pipelined fashion to increase throughput. The largest computational cost is in the correlation and minimum-finding operations, which are proportional to the number of pixels 100 times the number of disparities. The algorithm can use a sliding sums method to take advantage of redundancy in computing area sums, so that the window size used for area correlation does not substantially affect the associated computational cost. The resultant disparity map (M) can be further reduced in complexity by removing such extraneous objects such as road surface returns using a road surface filter (F).

The associated range resolution (Δr) is a function of the range r in accordance with the following equation:

$$Δ r = \frac{{r}^{2}}{b \cdot f} \cdot Δ d \qquad ( 2 )$$

The range resolution (Δr) is the smallest change in range r that is discernible for a given stereo geometry, corresponding to a change Δd in disparity (i.e. disparity resolution Δd). The range resolution (Δr) increases with the square of the range r, and is inversely related to the baseline b and focal length f, so that range resolution (Δr) is improved (decreased) with increasing baseline b and focal length f distances, and with decreasing pixel sizes which provide for improved (decreased) disparity resolution Δd.

Alternatively, a CENSUS algorithm may be used to determine the range-map image 80 from the associated first 40.1 and second 40.2 stereo intensity-image components, for example, by comparing rank-ordered difference matrices for corresponding pixels 100 separated by a given disparity d, wherein each difference matrix is calculated for each given pixel 100 of each of the first 40.1 and second 40.2 stereo intensity-image components, and each element of each difference matrix is responsive to a difference between the value of the given pixel 100 and a corresponding value of a corresponding surrounding pixel 100.

More particularly, the first stereo-vision camera 38.1 generates a first intensity-image component 40.1 of each real-world point P from a first viewpoint 42.1, and the second stereo-vision camera 38.2 generates a second intensity-image component 40.2 of each real-world point P from a second viewpoint 42.2, wherein the first 42.1 and second 42.2 viewpoints of view are separated by the above-described baseline b distance. Each of the first 40.1 and second 40.2 intensity-image components have the same total number of pixels 100 organized into the same number of rows 96 and columns 98, so that there is a one-to-one correspondence between pixels 100 in the first intensity-image component 40.1 and pixels 100 of like row 96 and column 98 locations in the corresponding second intensity-image component 40.2, and a similar one-to-one correspondence between pixels 100 in either the first 40.1 or second 40.2 intensity-image components and pixels 100 of like row 94 and column 102 locations in the corresponding range-map image 80, wherein the each pixel value of the first 40.1 or second 40.2 intensity-image components correspond to an intensity value at the given row 96 and column 98 location, whereas the pixel values of the corresponding range-map image 80 represent corresponding down-range coordinate r of that same row 94 and column 102 location.

For a given real-world point P, the relative locations of corresponding first 52.1 and second 52.2 image points thereof in the first 40.1 and second 40.2 intensity-image components are displaced from one another in their respective first 40.1 and second 40.2 intensity-image components by an amount—referred to as disparity—that is inversely proportional to the down-range coordinate r of the real-world point P. For each first image point 52.1 in the first intensity-image component 40.1, the stereo vision processor 78 locates—if possible—the corresponding second intensity-image point 52.2 in the second intensity-image component 40.2 and determines the down-range coordinate r of the corresponding associated real-world point P from the disparity between the first 52.1 and second 52.2 image points. This process is simplified by aligning the first 38.1 and second 38.2 stereo-vision cameras so that for each first image point 52.1 along a given row coordinate 96, J_{ROW} in the first intensity-image component 40.1, the corresponding associated epipolar curve in the second intensity-image component 40.2 is a line along the same row coordinate 96, J_{ROW} in the second intensity-image component 40.2, and for each second image point 52.2 along a given row coordinate 96, J_{ROW} in the second intensity-image component 40.2, the corresponding associated epipolar curve in the first intensity-image component 40.1 is a line along the same row coordinate 96, J_{ROW} in the first intensity-image component 40.1, so that corresponding first 52.1 and second 52.2 image points associated with a given real-world point P each have the same row coordinate 96, J_{ROW} so that the corresponding first 52.1 and second 52.2 image points can be found from a one-dimensional search along a given row coordinate 96, J_{ROW}. An epipolar curve in the second intensity-image component 40.2 is the image of a virtual ray extending between the first image point 52.1 and the corresponding associated real-world point P, for example, as described further by K. Konolige in “Small Vision Systems: Hardware and Implementation,” Proc. Eighth Int'l Symp. Robotics Research, pp. 203-212, October 1997, (hereinafter “KONOLIGE”), which is incorporated by reference herein. The epipolar curve for a pinhole camera will be a straight line. The first 38.1 and second 38.2 stereo-vision cameras are oriented so that the focal planes 48.1, 48.2 of the associated lenses 44.1, 44.2 are substantially coplanar, and may require calibration as described by KONOLIGE or in Application '059, for example, so as to remove associated lens distortions and alignment offsets, so as to provide for horizontal epipolar lines that are aligned with the row coordinates 96, J_{ROW} of the first 38.1 and second 38.2 stereo-vision cameras.

Accordingly, with the epipolar lines aligned with common horizontal scan lines, i.e. common row coordinates 96, J_{ROW}, of the first 38.1 and second 38.2 stereo-vision cameras, the associated disparities d or corresponding first 52.1 and second 52.2 image points corresponding to a given associated real-world point P will be exclusively in the X, i.e. horizontal, direction, so that the process of determining the down-range coordinate r of each real-world point P implemented by the stereo vision processor 78 then comprises using a known algorithm—for example, either what is known as the CENSUS algorithm, or an area correlation algorithm—to find a correspondence between first 52.1 and second 52.2 image points, each having the same row coordinates 96, J_{ROW} but different column coordinate 98, I_{COL} in their respective first 40.1 and second 40.2 intensity-image components, the associated disparity d either given by or responsive to the difference in corresponding column coordinates 98, I_{COL}. As one example, the CENSUS algorithm is described by R. Zabih and J. Woodfill in “Non-parametric Local Transforms for Computing Visual Correspondence,” Proceedings of the Third European Conference on Computer Vision, Stockholm, May 1994; by J Woodfill and B, Von Herzen in “Real-time stereo vision on the PARTS reconfigurable computer,” in Proceedings The 5th Annual IEEE Symposium on Field Programmable Custom Computing Machines, (April, 1997); by J. H. Kim, C. O. Park and J. D. Cho in “Hardware implementation for Real-time Census 3D disparity map Using dynamic search range,” from Sungkyunkwan University School of Information and Communication, Suwon, Korea; and by Y. K Baik, J. H. Jo and K. M. Lee in “Fast Census Transform-based Stereo Algorithm using SSE2,” in The 12th Korea-Japan Joint Workshop on Frontiers of Computer Vision, 2-3, February, 2006, Tokushima, Japan, pp. 305-309, all of which are incorporated herein by reference. As another example, the area correlation algorithm is described by KONOLIGE, also incorporated herein by reference. As yet another example, the disparity associated with each pixel 104 in the range-map image 80 may be found by minimizing either a Normalized Cross-Correlation (NCC) objective function, a Sum of Squared Differences (SSD) objective function, or a Sum of Absolute Differences (SAD) objective function, each objective function being with respect to disparity d, for example, as described in the following internet document: http:[slash][slash]3dstereophoto.blogspot.com[slash]2012[slash]01[slash]stereo-matching-local-methods.html, which is incorporated herein by reference, wherein along a given row coordinate 96, J_{ROW} of the first 40.1 and second 40.2 intensity-image components, for each column coordinate 98, I_{COL} in the first intensity-image component 40.1, the NCC, SSD or SAD objective functions are calculated for a first subset of pixels I₁(u,v) centered about the pixel I₁(I_{COL}, J_{ROW}), and a second subset of pixels I₂(u,v) centered about the pixel I₁(I_{COL}+DX, J_{ROW}), as follows:

$$\begin{matrix}N C C ( DX ( {I}_{COL} , {J}_{ROW} ) ) = \frac{{\sum }_{u , v} [ {I}_{1} ( u , v ) - {\overline{I}}_{1} ] \cdot [ {I}_{2} ( u + DX ( {I}_{COL} , {J}_{ROW} ) , v ) - {\overline{I}}_{2} ]}{\sqrt{{\sum }_{u , v} {[ {I}_{1} ( u , v ) - {\overline{I}}_{1} ]}^{2} \cdot \sqrt{{\sum }_{u , v}^{ } {[ {I}_{2} ( u + DX ( {I}_{COL} , {J}_{ROW} ) , v ) - {\overline{I}}_{2} ]}^{2}}}} & ( 3 ) \\ S S D ( DX ( {I}_{COL} , {J}_{ROW} ) ) = {\sum }_{u , v}^{ } {[ {I}_{1} ( u , v ) - {I}_{2} ( u + DX ( {I}_{COL} , {J}_{ROW} ) , v ) ]}^{2} & ( 4 ) \\ S A D ( DX ( {I}_{COL} , {J}_{ROW} ) ) = {\sum }_{u , v}^{ } \vert {I}_{1} ( u , v ) - {I}_{2} ( u + DX ( {I}_{COL} , {J}_{ROW} ) , v ) \vert \\ wherein & ( 5 ) \\ {\sum }_{u , v}^{ } = {\sum }_{u = {I}_{COL} - p}^{{I}_{COL} + p} {\sum }_{v = {J}_{ROW} - q}^{{J}_{ROW} + q} , and & ( 6 )\end{matrix}$$

the resulting disparity d is the value that minimizes the associated objective function (NCC, SSD or SAD). For example, in one embodiment, p=q=2.

Regardless of the method employed, the stereo vision processor 78 generates the range-map image 80 from the first 40.1 and second 40.2 intensity-image components, each comprising an N_{ROW}×N_{COL} array of image intensity values, wherein the range-map image 80 comprises an N_{ROW}×N_{COL} array of corresponding down-range coordinate r values, i.e.:

$$r ( {I}_{COL} , {J}_{ROW} ) = \frac{{C}_{z}}{\vert d ( {I}_{COL} , {J}_{ROW} ) \vert} \qquad ( 7 )$$

wherein each column 94, I_{COL} and row 102, J_{ROW} coordinate in the range-map image 80 is referenced to, i.e. corresponds to, a corresponding column 96, I_{COL} and row 98, J_{ROW} coordinate of one of the first 40.1 and second 40.2 intensity-image components, for example, of the first intensity-image component 40.1, and C_{Z} is calibration parameter determined during an associated calibration process.

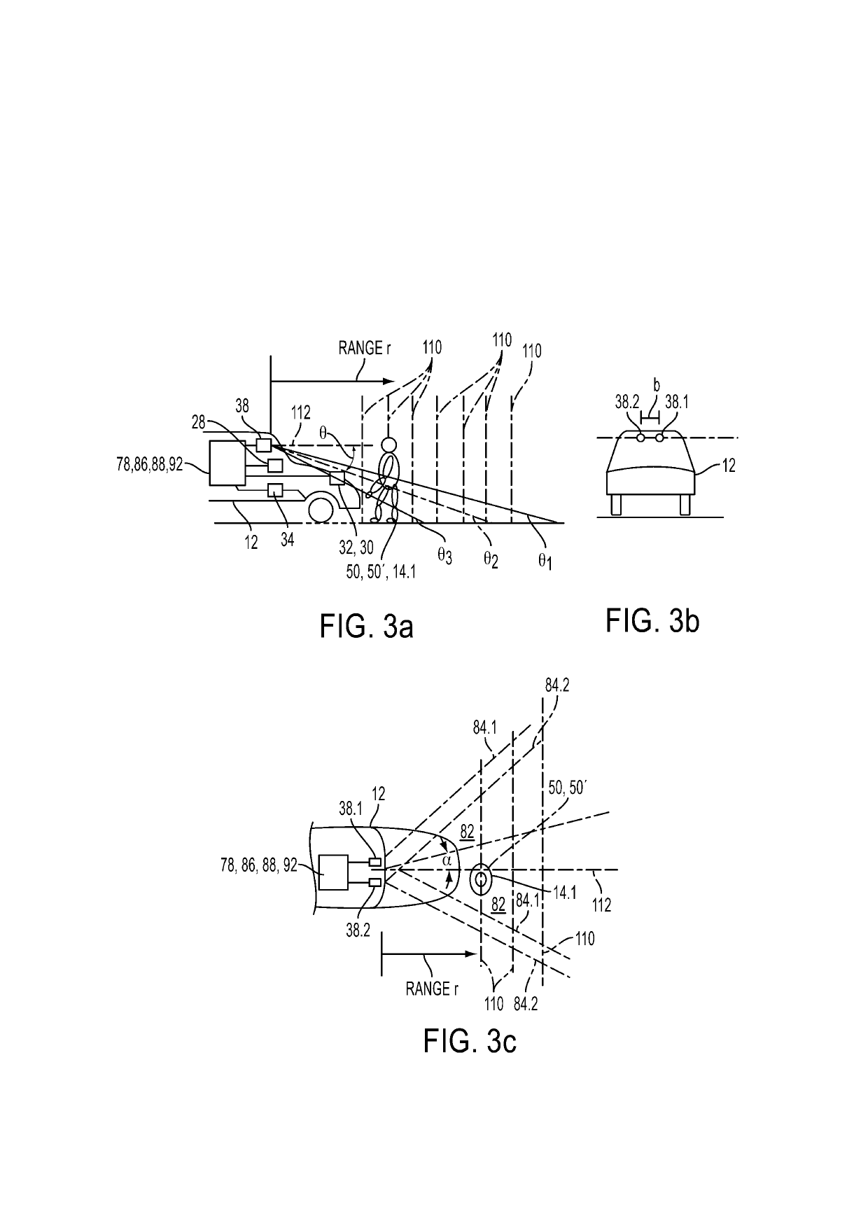

Referring to FIG. 3c, stereo imaging of objects 50—i.e. the generation of a range-map image 80 from corresponding associated first 40.1 and second 40.2 stereo intensity-image components—is theoretically possible for those objects 50 located within a region of overlap 82 of the respective first 84.1 and second 84.2 fields-of-view respectively associated with the first 42.1, 72.1 and second 42.2, 72.2 viewpoints of the associated stereo-vision system 16, 16′. Generally, as the range r to an object 50 decreases, the resulting associated disparity d increases, thereby increasing the difficulty of resolving the range r to that object 50. If a particular point P on the object 50 cannot be resolved, then the corresponding pixel 104 of the associated range-map image 80 will be blank or zero. On-target range fill (OTRF) is the ratio of the number of non-blank stereo range measurement pixels 104 to the total number of pixels 104 bounded by the associated object 50, that latter of which provides a measure of the projected surface area of the object 50. Accordingly, for a given object 50, the associated on-target range fill (OTRF) generally decreases with decreasing range r.

Accordingly, the near-range detection and tracking performance based solely on the range-map image 80 from the stereo-vision processor 78 can suffer if the scene illumination is sub-optimal or when object 50 lacks unique structure or texture, because the associated stereo matching range fill and distribution are below acceptable limits to ensure a relatively accurate object boundary reconstruction. For example, the range-map image 80 can be generally used for detection and tracking operations if the on-target range fill (OTRF) is greater than about 50 percent.

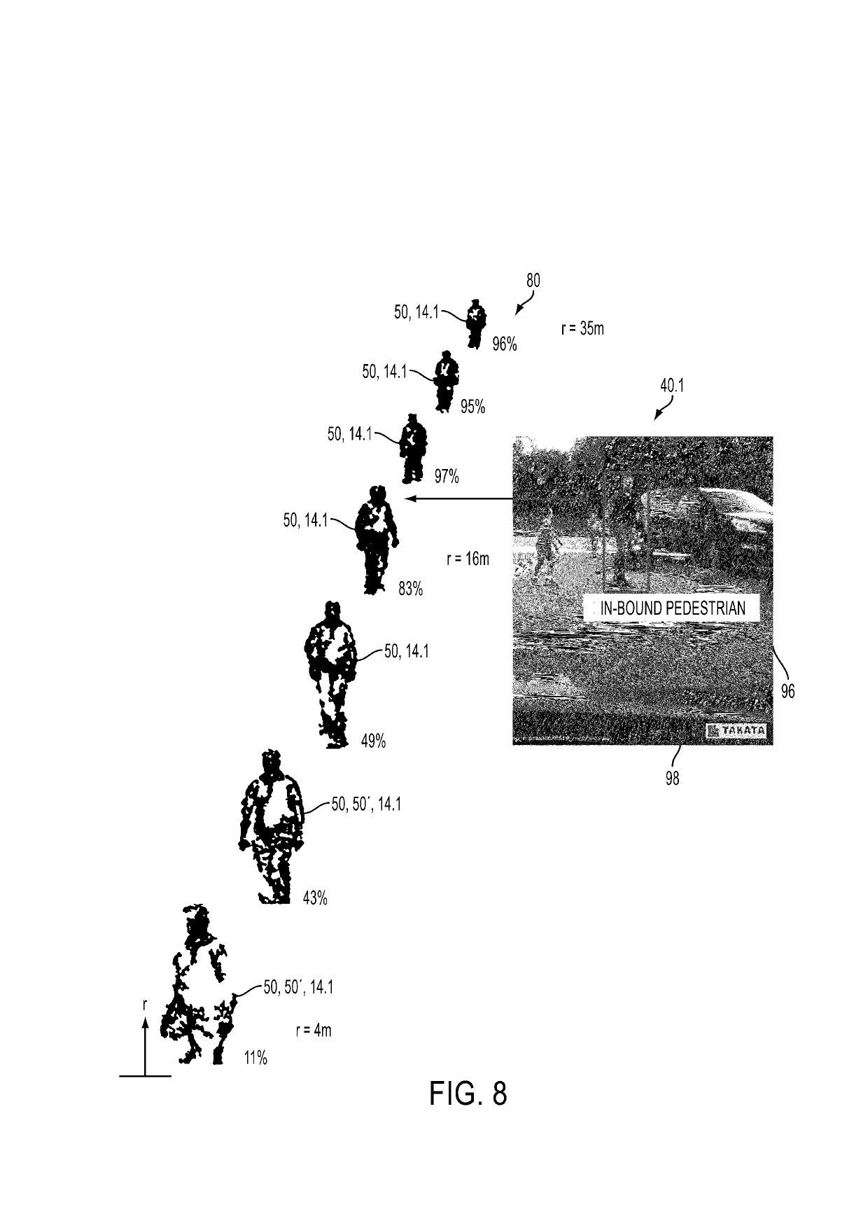

It has been observed that under some circumstances, the on-target range fill (OTRF) can fall below 50 percent with relatively benign scene illumination and seemly relatively good object texture. For example, referring to FIG. 8, there is illustrated a plurality of portions of a plurality of range-map images 80 of an inbound pedestrian at a corresponding plurality of different ranges r, ranging from 35 meters to 4 meters—from top to bottom of FIG. 8—wherein at 35 meters (the top silhouette), the on-target range fill (OTRF) is 96 percent; at 16 meters (the middle silhouette), the on-target range fill (OTRF) is 83 percent; at 15 meters, the on-target range fill (OTRF) drops below 50 percent; and continues progressively lower as the pedestrian continues to approach the stereo-vision system 16, until at 4 meters, the on-target range fill (OTRF) is only 11 percent.

Referring to FIG. 9, the stereo-vision object detection system 10 provides for processing the range-map image 80 in cooperation with one of the first 40.1 and second 40.2 stereo intensity-image components so as to provide for detecting an object 50 at relatively close ranges r for which the on-target range fill (OTRF) is not sufficiently large so as to otherwise provide for detecting the object 50 from the range-map image 80 alone. More particularly, stereo-vision object detection system 10 incorporates additional image processing functionality, for example, implemented in an image processor 86 in cooperation with an associated object detection system 88, that provides for generating from a portion of one of the first 40.1 or second 40.2 stereo intensity-image components an image 90 of a near-range object 50′, or of a plurality of near-range objects 50′, suitable for subsequent discrimination of the near-range object(s) 50′ by an associated object discrimination system 92, wherein the portion of the first 40.1 or second 40.2 stereo intensity-image components is selected responsive to the range-map image 80, in accordance with an associated stereo-vision object detection process 1000 described more fully hereinbelow.

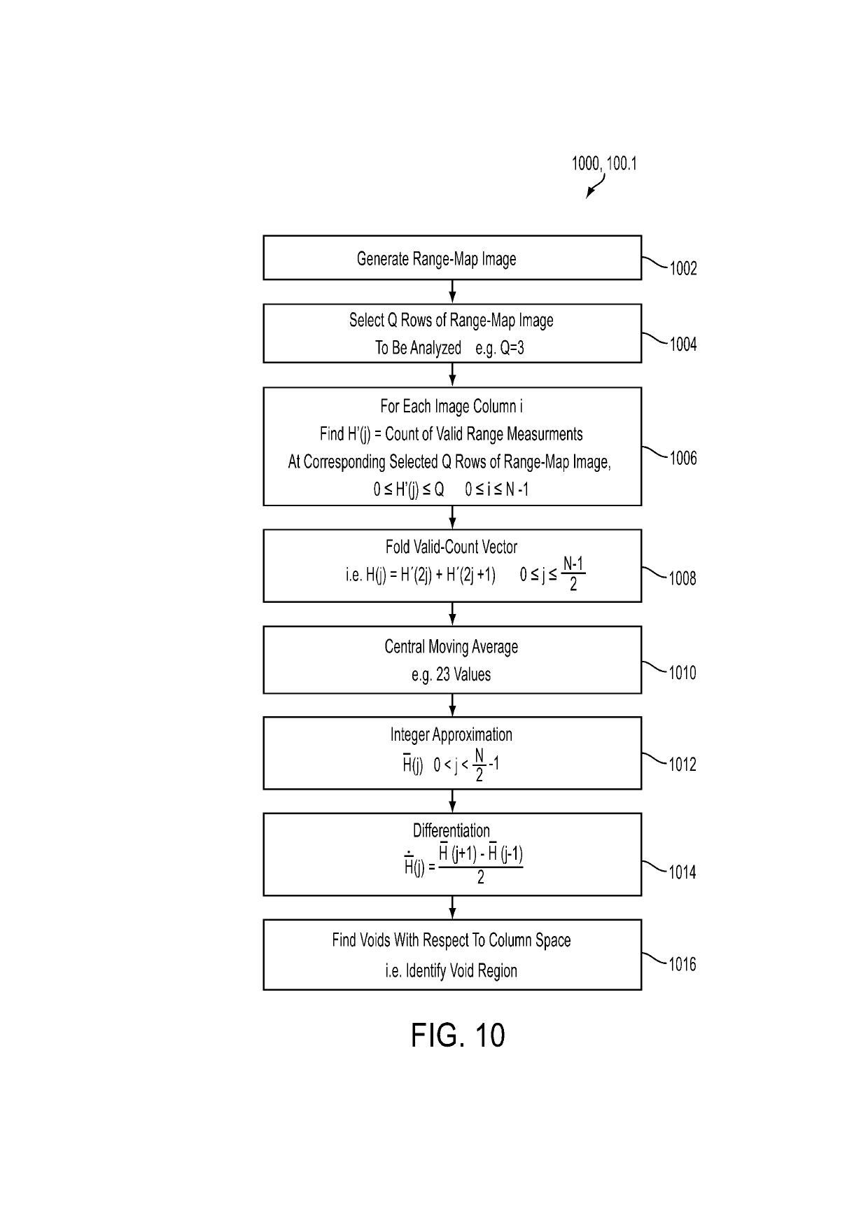

Referring to FIG. 10, a first portion 1000.1 of the stereo-vision object detection process 1000 provides for generating and then analyzing a range-map image 80 to identify one or more regions of void values therein—prospectively caused by one or more associated near-range objects 50′—that can then be used to define corresponding regions in one of the first 40.1 or second 40.2 stereo intensity-image components within which to further analyze for the one or more associated near-range objects 50′.

More particularly, in step (1002), a range-map image 80 is first generated by the stereo-vision processor 78 responsive to the first 40.1 or second 40.2 stereo intensity-image components, in accordance with the methodology described hereinabove. For example, in one embodiment, the stereo-vision processor 78 is implemented with a Field Programmable Gate Array (FPGA).

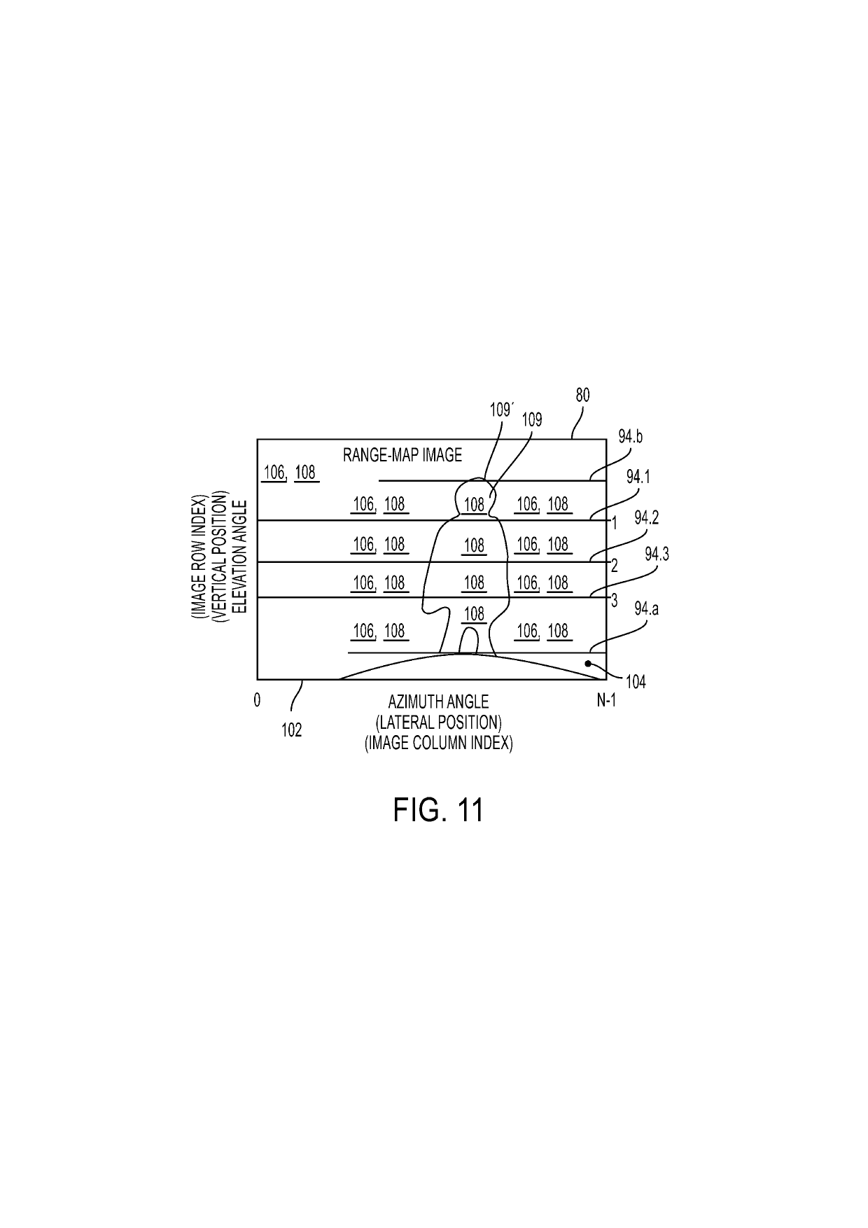

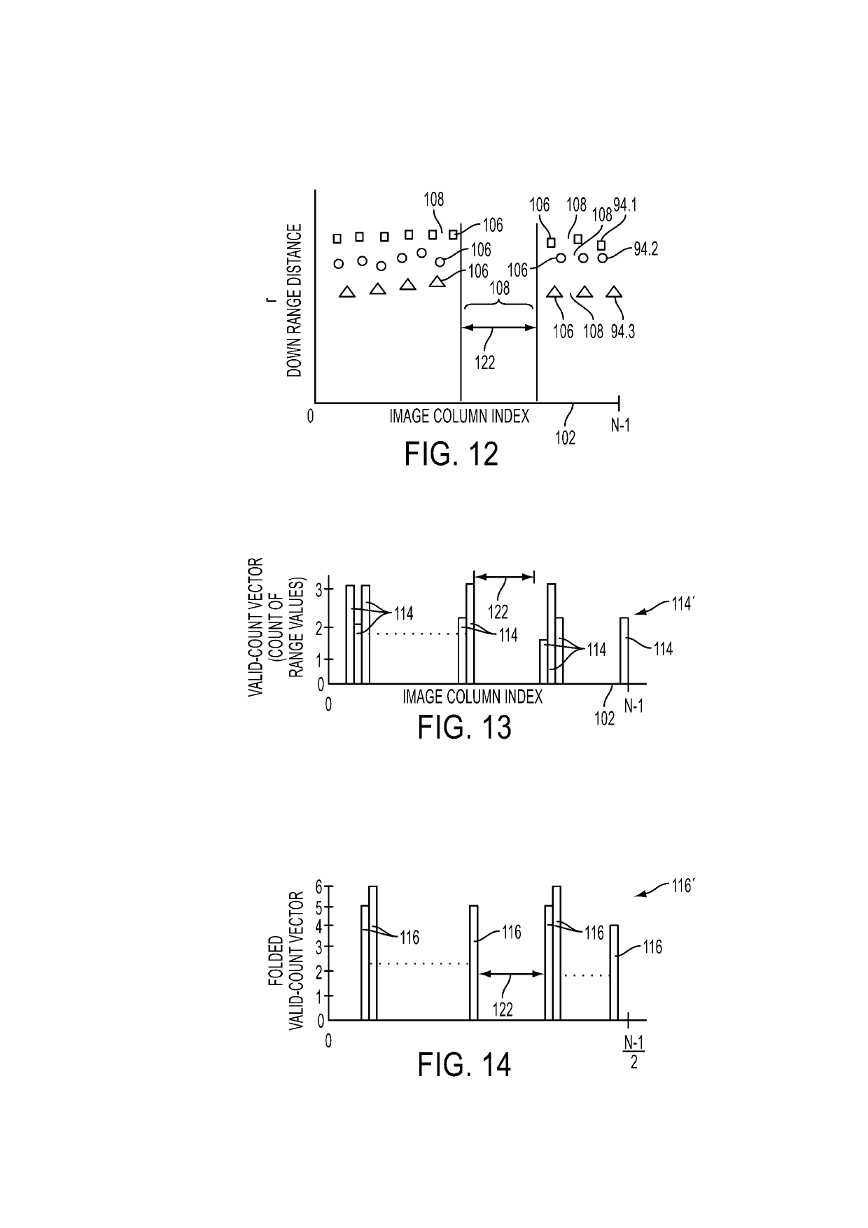

Referring to FIGS. 10, 3a and 11, in step (1004), Q rows 94 of the range-map image 80 are selected to be analyzed by the image processor 86, wherein, for example, in one embodiment, Q=3. For example, in one embodiment, the image processor 86 is implemented by a digital signal processor (DSP). Each stereo-vision camera 38 is inherently an angle sensor of light intensity, wherein each pixel 100 represents an instantaneous angular field of view at a given angles of elevation θ and azimuth α. Similarly, the associated stereo-vision system 16 is inherently a corresponding angle sensor that provides for sensing range r as a function of elevation θ and azimuth α. Accordingly, each row 94.1, 94.2, 94.3 of the range-map image 80 corresponds to a corresponding elevation angle θ₁, θ₂, θ₃. For the first 40.1 and second 40.2 stereo intensity-image components—each comprising an array of L rows 96 and N columns 98 of intensity pixels 100—the resulting range-map image 80 will comprise L rows 94 and N columns 102 of range pixels 104, wherein each range pixel 104 will have either a valid range value 106 if the corresponding range r can be resolved from the first 40.1 or second 40.2 stereo intensity-image components, or will have a void value 108 if the corresponding range r cannot be so resolved. Accordingly, FIG. 11 illustrates an example of a range-map image 80 comprising a region 109 of substantially only void values 108—illustrated by an associated silhouette 109′—surrounded primarily by valid range values 106, possibly interspersed with void values 108. The range r of the associated range value corresponds to the distance from the stereo-vision system 16 to a corresponding plane 110, wherein the plane 110 is normal to the axial centerline 112 of the stereo-vision system 16, and the axial centerline 112 is normal to the baseline b through a midpoint thereof and parallel to the optic axes of the first 38.1 and second 38.2 stereo-vision cameras. Accordingly, referring to FIG. 12, each row 94.1, 94.2, 94.3 of the range-map image 80 comprises a vector of N range pixels 104, wherein each range pixel 104 comprises either a valid range value 106—i.e. having a value of the corresponding range r,—or a void value 108.

Referring to FIGS. 10 and 13, in step (1006), a corresponding element 114 of a valid-count vector 114′, H( )′ is calculated for each column 102 of the range-map image 80 and is given by the sum of corresponding valid range values 106 of the Q rows 94, 94.1, 94.2, 94.3 of the range-map image 80 for that column 102, so that the value of each element 114 will then be an integer between 0 and Q. For example, for Q=3, each element 114 of the valid-count vector 114′, H′(i) for the i^{th} column 102, will have a value of either 0, 1, 2 or 3, for i between 0 and N−1.

Then, referring also to FIGS. 10 and 14, in step (1008), the valid-count vector 114′, H( )′ is folded so as to thereby generate a folded valid-count vector 116′, H( ) having half the number of elements—i.e. N/2—, wherein every two successive elements of the valid-count vector 114′, H′(2j), H′(2j+1) (functioning as an intermediate valid-count vector) are summed together to give a corresponding element H(j) of the folded valid-count vector 116′, for j between 0 and (N−1)/2, so that the value of each element 116 of the folded valid-count vector 116′, H( ) has a value between 0 and 2Q.

In step (1010), the folded valid-count vector 116′, H( ) is filtered with a smoothing filter, for example, in one embodiment, a central moving average filter, wherein, for example, in one embodiment, the corresponding moving average window comprises 23 elements, so that every successive group of 23 elements of the folded valid-count vector 116′, H( ) are averaged to form a resulting corresponding filtered value, which, in step (1012), is then replaced with a corresponding integer approximation thereof, so as to generate a resulting integer-filtered-folded valid-count vector 118′ H̅( ).

In step (1014), the integer-filtered-folded valid-count vector 118, H̅( ) is differentiated in accordance with a central difference with respect to each element 118, H̅(j) of the integer-filtered-folded valid-count vector 118′ H̅( ) so as to form a resulting vector of differential values 120′, \dot{H}( ), each element 120, \dot{H}(j) of which is given by:

$$\dot{H} ( j ) = \frac{\overline{H} ( j + 1 ) - \overline{H} ( j - 1 )}{2} . \qquad ( 8 )$$

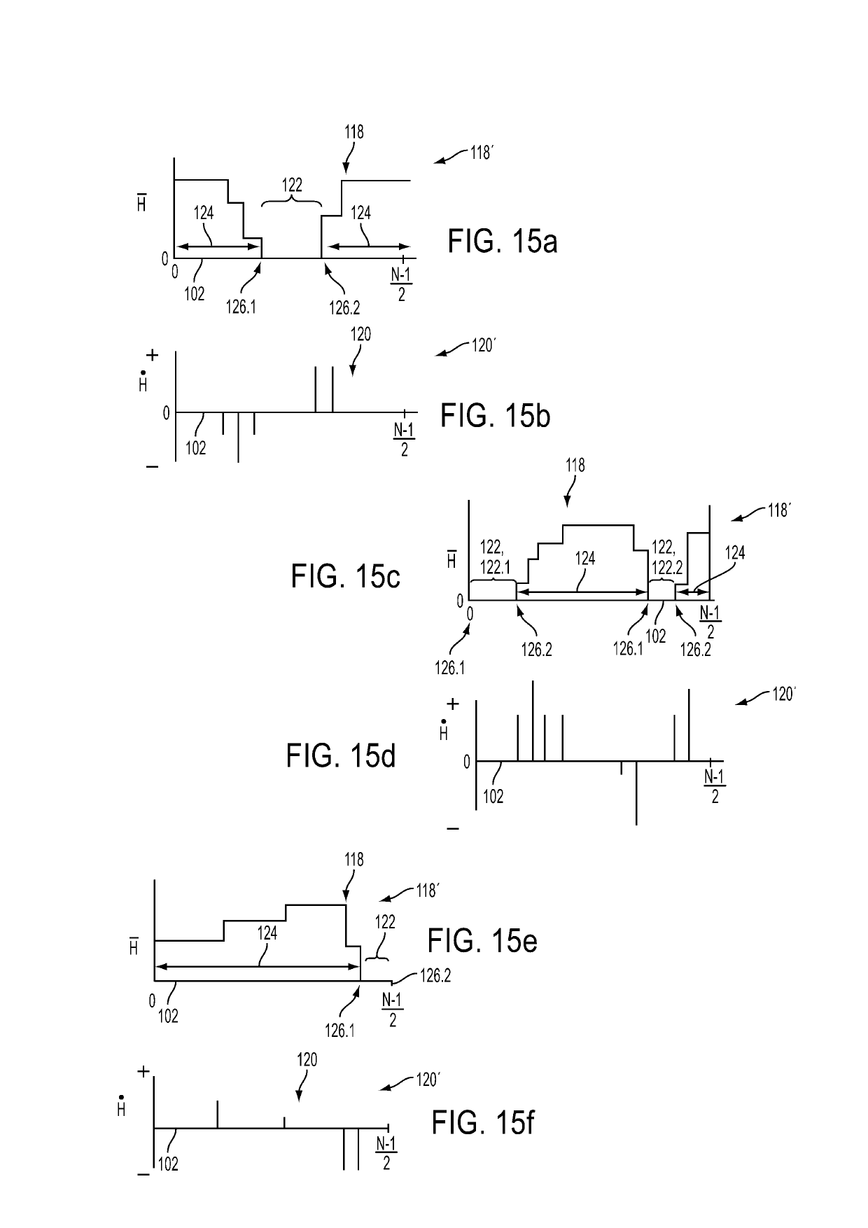

In step (1016), the vector of differential values 120′, \dot{H}( ) is used to locate void regions 122 in the column space of the range-map image 80 and the first 40.1 and second 40.2 stereo intensity-image components. Generally, a particular void region 122 will be either preceded or followed—or both—in column space by a region 124 associated with valid range values 106. The differential value 120, \dot{H}(j) at a left-most boundary of a void region 122 adjacent to a preceding region associated with valid range values 106 will be negative, and the differential value 120, \dot{H}(j) at a right-most boundary of a void region 122 adjacent to a following region 124 associated with valid range values 106 will be positive. Accordingly, these differential values 120, \dot{H}(j) may be used to locate the associated left 126.1 and right 126.2 column boundaries of a particular void region 122. For example, referring to FIGS. 15a and 15b the left column boundary 126.1 of the void region 122 is located at the index j where the value of the integer-filtered-folded valid-count vector 118′ H̅(j) is equal to zero and where or proximate to where the corresponding value of the vector of differential values 120′, \dot{H}(j) is negative; and the right column boundary 126.2 of the void region 122 is located at the index j where the value of the integer-filtered-folded valid-count vector 118′ H̅(j) is equal to zero and where or proximate to where the corresponding value of the vector of differential values 120′, \dot{H}(j) is positive.

Conceivably, one of the left 126.1 or right 126.2 column boundaries of a particular void region 122 could be at a boundary of the range-map image 80, i.e. at either column 0 or column N−1. For example, referring to FIGS. 15c and 15d, illustrating two void regions 122.1, 122.2, the first void region 122.1 is located at the left side of the range-map image 80, so the corresponding first column boundary 126.1 is at column 0 at which the corresponding value of the integer-filtered-folded valid-count vector 118′ H̅(0) is equal to zero. Similarly, referring to FIGS. 15e and 15f, the void region 122 is located at the right side of the range-map image 80, so the corresponding second column boundary 126.2 is at column N−1 at which the corresponding value of the integer-filtered-folded valid-count vector 118′

$$\overline{H} ( \frac{N - 1}{2} )$$

is equal to zero.

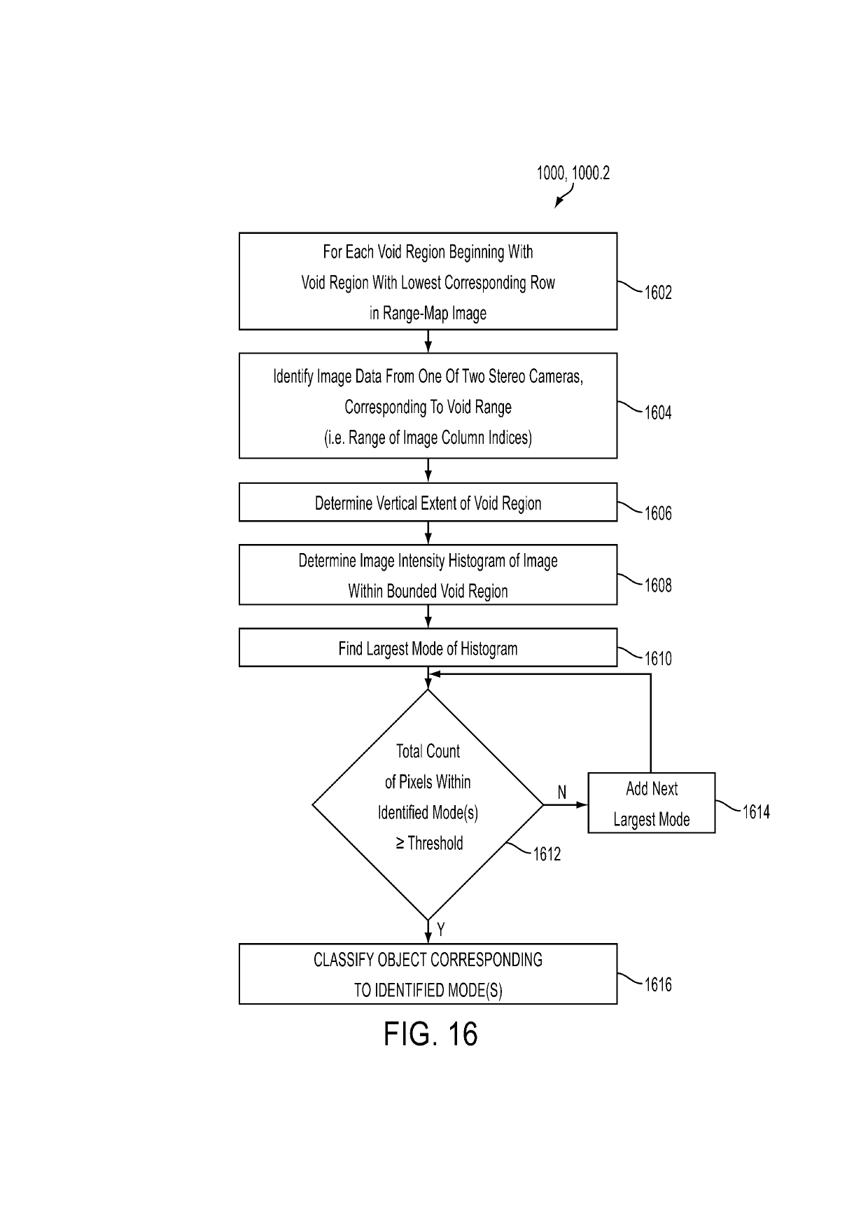

Referring to FIG. 16, given the locations of the left 126.1 or right 126.2 column boundaries of each void region 122 as determined from the range-map image 80 by the first portion 1000.1 of the stereo-vision object detection process 1000, a second portion 1000.2 of the stereo-vision object detection process 1000 then provides for processing the associated intensity pixels 100 within the corresponding left 126.1 or right 126.2 column boundaries of one of the first 40.1 or second 40.2 stereo intensity-image components in order to detect any associated near-range objects 50′ being imaged therein.

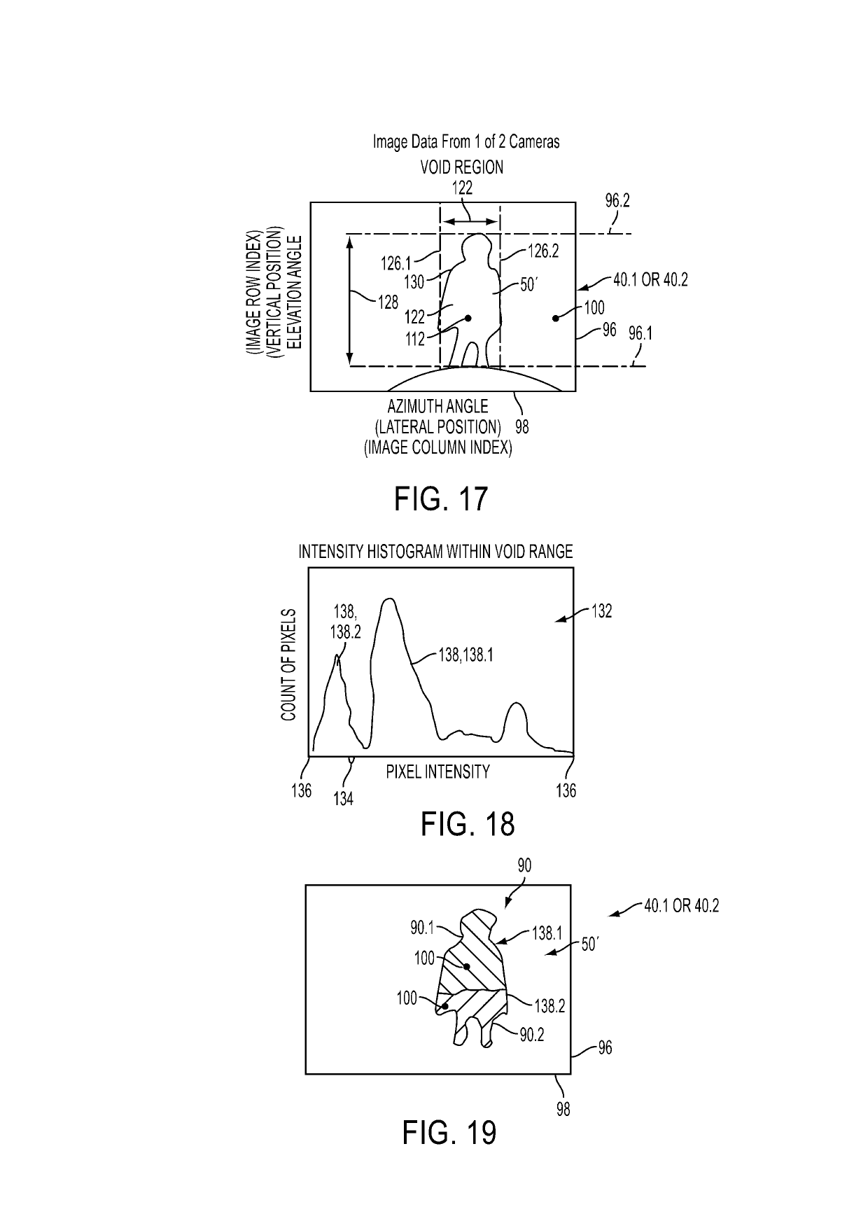

More particularly, in step (1602), for each void region 122, and beginning with the first void region 122.1 having the lowest row 94 of range pixels 104 that contains void values 108—prospectively corresponding to the nearest near-range object 50′,—then in step (1604), the corresponding intensity pixels 100 of one of the first 40.1 or second 40.2 stereo intensity-image components are identified within the corresponding left 126.1 and right 126.2 column boundaries of the void region 122, for example, as illustrated in FIG. 17. Furthermore, in step (1606), the vertical extent 128 of the void region 122 is determined by identifying the lowermost 94.a and uppermost 94.b rows of range pixels 104 containing void values 108 that are contiguous with other void values 108 within the void region 122. Accordingly, the prospective near-range object 50′ is laterally bounded within the first 40.1 or second 40.2 stereo intensity-image component by the left 126.1 and right 126.2 column boundaries, and is vertically bounded therewithin by the lowermost 96.1 and uppermost 96.2 rows of intensity pixels 100 corresponding to the lowermost 94.a and uppermost 94.b rows of range pixels 104, thereby defining a corresponding vertically-bounded void region 130 within the first 40.1 or second 40.2 stereo intensity-image component.

Referring to FIG. 18, in step (1608), an image-intensity histogram 132 is determined from the intensity pixels 100 within the vertically-bounded void region 130 as a count of intensity pixels 100 for each pixel intensity bin 134, wherein the overall range of pixel intensities 136 is subdivided into a plurality of pixel intensity bins 134. For example, in one embodiment, the difference between the maximum and minimum intensity for each pixel intensity bin 134 is substantially the same. As illustrated in FIG. 18, the image-intensity histogram 132 exhibits a plurality of modes 138, 138.1, 138.2. Each intensity pixel 100 classified within the image-intensity histogram 132 is mapped to the corresponding first 40.1 or second 40.2 stereo intensity-image component, thereby enabling all of the intensity pixels 100 associated with a given modes 138 to be associated with a corresponding portion of the first 40.1 or second 40.2 stereo intensity-image component within the corresponding vertically-bounded void region 130. The image-intensity histogram 132 provides for reconstructing the boundary of a near-range object 50′ imaged within the vertically-bounded void region 130 responsive to the identification of intensity-correlated intervals within the multi-modal image-intensity histogram 132, based on the presumption that foreground and background objects are illuminated differently, and that correlated intensity pixels 100—i.e. intensity pixels 100 that are related to one another in respect of being associated with common portions of the near-range object 50′—will have a similar intensity. Accordingly, the union of correlated intensity levels provides for determining the boundary of the near-range object 50′.

More particularly, in step (1610), the largest mode 138, 138.1—for example, the mode 138 having either the largest amplitude or the largest total number of associated intensity pixels 100—is first identified. Then, in step (1612), if the total count of intensity pixels 100 within the identified mode 138, 138.1 is less than a threshold, then, in step (1614), the next largest mode 138, 138.2 is identified and step (1612) is repeated, but for the total count of all identified modes 138, 138.1, 138.2. For example, in one embodiment, the threshold used in step (1612) is 60 percent of the total number of intensity pixels 100 within the vertically-bounded void region 130.

For example, referring to FIG. 19, first 90.1 and second 90.2 portions of an intensity-image 90 of the near-range object 50′ illustrated in FIG. 17 respectively correspond to respective first 138.1 and second 138.2 modes of the corresponding image-intensity histogram 132 illustrated in FIG. 18.

If, in step (1612) the total count of intensity pixels 100 within the identified mode 138, 138.1 is greater than or equal to the threshold, then, in step (1616), the resulting intensity-image 90 of the prospective near-range object 50′ is classified by the object discrimination system 92, for example, in accordance with the teachings of U.S. patent application Ser. No. 11/658,758 filed on 29 Sep. 2008, entitled Vulnerable Road User Protection System, or U.S. patent application Ser. No. 13/286,656 filed on 16 Nov. 2011, entitled Method of Identifying an Object in a Visual Scene, which are incorporated herein by reference. For example, the prospective near-range object 50′ may be classified using any or all of the metrics of an associated feature vector described therein, i.e.
1. the size of the segmented area;
2. the row of the camera focal plane array that contains the binary center of mass of the segmented area;
3. the column of the camera focal plane array that contains the binary center of mass of the segmented area;
4. the vertical extent of the object;
5. the horizontal extent of the object;
6. the best-fit rectangle aspect ratio;
7. the best-fit rectangle fill factor (i.e. fraction of the best fit rectangle that is filled by the segmented area);
8. the best-fit ellipse major axis angle with respect to vertical;
9. the best-fit ellipse major and minor axes ratio;
10. the best correlation of the object's harmonic profile after the application of a 19 element central moving average filter with the stored set of harmonic profiles;
11. the best correlation of the object's harmonic profile after the application of a 7 element central moving average filter with the stored set of harmonic profiles; or
12. the maximum horizontal extent of the object in lower half of the best-fit rectangle,
   wherein the associated segmented area is defined by the corresponding intensity image 90 of the prospective near-range object 50′, or the associated first 90.1 or second 90.2 portions thereof, and the associated feature vector may be analyzed by the one or more neural networks described in U.S. patent application Ser. Nos. 11/658,758 and 13/286,656 so as to provide for classifying the prospective near-range object 50′.

Accordingly, the stereo-vision object detection system 10 together with the associated first 1000.1 and second 1000.2 portions of the associated stereo-vision object detection process 1000 provide for detecting relatively near-range objects 50′ that might not otherwise be detectable from the associated range-map image 80 alone. Notwithstanding that the stereo-vision object detection system 10 has been illustrated in the environment of a vehicle 12 for detecting an associated vulnerable road user 14, it should be understood that the stereo-vision object detection system 10 is generally not limited to this, or any one particular application, but instead could be used in cooperation with any stereo-vision system 16 to facilitate the detection of objects 50, 50′ that might not be resolvable in the associated resulting range-map image 80, but for which there is sufficient intensity variation in the associated first 40.1 or second 40.2 stereo intensity-image components to be resolvable using an associated image-intensity histogram 132.

In accordance with another aspect, in situations where the region 109 of void values 108 is substantially limited to the near-range object 50′, the near-range object 50′ can be detected directly from the range-map image 80, for example, by analyzing the region 109 of void values 108 directly, for example, in accordance with the teachings of U.S. patent application Ser. Nos. 11/658,758 and 13/286,656, which are incorporated herein by reference, for example, by extracting an analyzing a harmonic profile of the associated silhouette 109′ of the region 109. For example, a region surrounding the region 109 of void values 108 may be first transformed to a binary segmentation image, which is then analyzed in accordance with the teachings of U.S. patent application Ser. Nos. 11/658,758 and 13/286,656 so as to provide for detecting and/or classifying the associated near-range object 50′.

Furthermore, notwithstanding that the stereo-vision processor 78, image processor 86, object detection system 88 and object discrimination system 92 have been illustrated as separate processing blocks, it should be understood that any two or more of these blocks may be implemented with a common processor, and that the particular type of processor is not limiting.

Yet further, it should be understood that the stereo-vision object detection system 10 is not limited in respect of the process by which the range-map image 80 is generated from the associated first 40.1 and second 40.2 stereo intensity-image components.

While specific embodiments have been described in detail in the foregoing detailed description and illustrated in the accompanying drawings, those with ordinary skill in the art will appreciate that various modifications and alternatives to those details could be developed in light of the overall teachings of the disclosure. It should be understood, that any reference herein to the term “or” is intended to mean an “inclusive or” or what is also known as a “logical OR”, wherein when used as a logic statement, the expression “A or B” is true if either A or B is true, or if both A and B are true, and when used as a list of elements, the expression “A, B or C” is intended to include all combinations of the elements recited in the expression, for example, any of the elements selected from the group consisting of A, B, C, (A, B), (A, C), (B, C), and (A, B, C); and so on if additional elements are listed. Furthermore, it should also be understood that the indefinite articles “a” or “an”, and the corresponding associated definite articles “the’ or “said”, are each intended to mean one or more unless otherwise stated, implied, or physically impossible. Yet further, it should be understood that the expressions “at least one of A and B, etc.”, “at least one of A or B, etc.”, “selected from A and B, etc.” and “selected from A or B, etc.” are each intended to mean either any recited element individually or any combination of two or more elements, for example, any of the elements from the group consisting of “A”, “B”, and “A AND B together”, etc. Yet further, it should be understood that the expressions “one of A and B, etc.” and “one of A or B, etc.” are each intended to mean any of the recited elements individually alone, for example, either A alone or B alone, etc., but not A AND B together. Furthermore, it should also be understood that unless indicated otherwise or unless physically impossible, that the above-described embodiments and aspects can be used in combination with one another and are not mutually exclusive. Accordingly, the particular arrangements disclosed are meant to be illustrative only and not limiting as to the scope of the invention, which is to be given the full breadth of the appended claims, and any and all equivalents thereof.

What is claimed is:

1. A method of processing images of a visual scene, comprising:
a. receiving or determining a range-map image of the visual scene, wherein said range-map image is generated from first and second stereo intensity-image components of said visual scene, said range-map image is organized as an array of range pixels, each row of said array of range pixels corresponds to a different elevation angle in said visual scene, each column of said array of range pixels corresponds to a different azimuth angle in said visual scene, and each range pixel of said array of range pixels is representative of a corresponding range value;
b. locating one or more void regions of said range-map image, if any, for which each associated said range pixel has a void value; and
c. detecting an object in said visual scene responsive to said one or more void regions of said range-map image for which each associated said range pixel has said void value.

2. A method of processing images of a visual scene as recited in claim 1, wherein the operation of receiving or determining said range-map image comprises:
a. receiving said first and second stereo intensity-image components of said visual scene; and
b. determining said range-map image from said first and second stereo intensity-image components.

3. A method of processing images of a visual scene as recited in claim 1, wherein the operation of locating said one or more regions of said range-map image for which each associated said range pixel has said void value comprises:
a. selecting a plurality of different rows of said range-map image;
b. for each column of a plurality of columns of said range-map image: determining a corresponding value of a corresponding element of a valid-count vector, wherein said corresponding value is representative of a count of valid values of said range-map image at said plurality of different rows for a corresponding at least one said column of said plurality of columns, and different elements of said valid-count vector correspond to different columns of said range-map image; and
c. locating said one or more void regions of said range-map image, if any, of said range-map image for which each associated said range pixel has said void value by analyzing said valid-count vector.

4. A method of processing images of a visual scene as recited in claim 3, wherein the operation of determining said corresponding value of said corresponding element of said valid-count vector comprises:
a. determining a corresponding value of a corresponding element of an intermediate valid-count vector, wherein said corresponding value of said corresponding element of said intermediate valid-count vector is representative of a count of valid values of said range-map image at said plurality of different rows for a corresponding column of said plurality of columns; and
b. summing adjacent values of said intermediate valid-count vector so as to form a corresponding value of said valid-count vector.

5. A method of processing images of a visual scene as recited in claim 3, wherein the operation of locating said one or more void regions of said range-map image is responsive to a spatial differentiation of said valid-count vector with respect to corresponding column position.

6. A method of processing images of a visual scene as recited in claim 4, wherein the operation of locating said one or more void regions of said range-map image comprises differentiating an integer-filtered valid-count vector with respect to corresponding column position so as to generate corresponding derivative values, wherein said integer-filtered valid-count vector is generated by integer quantization following a spatial filtering of said valid-count vector, and said one or more void regions are located between column positions responsive to at least one corresponding polarity of said derivative values.

7. A method of processing images of a visual scene as recited in claim 6, wherein the operation of spatial filtering comprises filtering using a central moving average filter.

8. A method of processing images of a visual scene as recited in claim 1, wherein if said one or more void regions are located, the operation of detecting said object in said visual scene comprises analyzing a portion of an intensity image of said visual scene corresponding to said one or more void regions so as to provide for detecting a corresponding said object in said visual scene, wherein said intensity image of said visual scene is in correspondence with said range-map image, and each intensity pixel of said intensity image is representative of an intensity value corresponding to a corresponding said range pixel of said range-map image.

9. A method of processing images of a visual scene as recited in claim 8, wherein the operation of analyzing said portion of said intensity image of said visual scene commences with a first void region of said one or more void regions having a lowest corresponding said row in said range-map image relative to another void region of said one or more void regions.

10. A method of processing images of a visual scene as recited in claim 8, wherein for each void region of said one or more void regions, the operation of analyzing said portion of said intensity image of said visual scene comprises:
a. determining a column extent of said void region of said range-map image;
b. determining a row extent of said void region of said range-map image; and
c. analyzing either a portion of said range-map image or a corresponding portion of said intensity image, wherein said portion is within a rectangle bounded by said row and column extents.

11. A method of processing images of a visual scene as recited in claim 10, wherein the operation of locating said one or more regions of said range-map image for which each associated said range pixel has said void value comprises:
a. selecting a plurality of different rows of said range-map image; and
b. for each column of a plurality of columns of said range-map image: determining a corresponding value of a corresponding element of a valid-count vector, wherein said corresponding value is representative of a count of valid values of said range-map image at said plurality of different rows for a corresponding at least one said column of said plurality of columns, different elements of said valid-count vector correspond to different columns of said range-map image, and said column extent is determined from said valid-count vector.

12. A method of processing images of a visual scene as recited in claim 10, wherein for each said void region of said one or more void regions, the operation of analyzing said portion of said intensity image of said visual scene comprises:
a. generating an image-intensity histogram of said portion of said intensity image bounded by said row and column extents; and
b. analyzing said portion of said intensity image responsive to said image-intensity histogram.

13. A method of processing images of a visual scene as recited in claim 12, wherein for each said void region of said one or more void regions, the operation of analyzing said portion of said intensity image of said visual scene further comprises:
a. locating at least one mode of said image-intensity histogram so that a total count of all intensity pixels associated with said at least one mode meets or exceeds a threshold; and
b. detecting said object from said intensity pixels associated with said at least one mode.

14. A method of processing images of a visual scene as recited in claim 13, further comprising providing for classifying said object detected from said intensity pixels associated with said intensity pixels associated with said at least one mode.

15. A method of processing images of a visual scene as recited in claim 13, further comprising:
a. associating different portions of said object with different subsets of said intensity pixels associated with different modes of said image-intensity histogram; and
b. providing for classifying said object detected from said intensity pixels associated with said at least one mode responsive to said different portions of said object associated with said different subsets of said intensity pixels associated with said different modes of said image-intensity histogram.

16. An object detection system, comprising:
a. a stereo-vision system, comprising:
i. first and second cameras; and
ii. a stereo-vision processor that provides for generating a range-map image of a visual scene from associated first and second image signals respectively generated by said first and second cameras of said stereo-vision system viewing said visual scene, wherein said range-map image comprises a plurality of range pixels organized in an array of rows and columns, different said rows correspond to different elevation angles relative to a central axis of said first and second cameras, different said columns correspond to different azimuth angles relative to said central axis of said first and second cameras, and each range pixel of said plurality of range pixels comprises one of a valid range value and a void value;
b. an imaging system, wherein said imaging system provides for generating an intensity image of said visual scene, said image comprises a plurality of intensity pixels organized in an array of rows and columns, said plurality of intensity pixels is equal in number to said plurality of range pixels, and said rows and columns of said intensity image are synchronized with said rows and columns of said range-map image; and
c. at least one image processor, wherein said at least one processor provides for:
i. locating a region of void range-pixel values in said range-map image; and
ii. detecting from a corresponding region of said intensity image an object of said visual scene associated with said region of void range-pixel values.

17. An object detection system as recited in claim 16, wherein said imaging system comprises one of said first and second cameras of said stereo-vision system.
